(19) United States
(12) Patent Application Publication
(10) Pub. No.: US 2025/0365744 A1
(43) Pub. Date: Nov. 27, 2025

(54) METHODS FOR HANDLING SIDELINK COMMUNICATION WITH A GROUP OF WIRELESS DEVICES ASSOCIATED WITH A PREDETERMINED GEOGRAPHICAL AREA AND RELATED DEVICES

(71) Applicant: Sony Group Corporation, Tokyo (JP)

(72) Inventors: Torgny PALENIUS, Barsebäck (SE); Johan HILL, Lund (SE)

(21) Appl. No.: 18/875,130

(22) PCT Filed: Jun. 7, 2023
(86) PCT No.: PCT/EP2023/065253

§ 371 Date: Dec. 14, 2024

(30) Foreign Application Priority Data
Jun. 22, 2022 (SE) 2250766-9

(51) Int. Cl. H04W 72/25; H04W 4/02; H04W 48/14

(52) U.S. Cl. CPC H04W 72/25; H04W 4/025; H04W 48/14

(57) ABSTRACT

A method is disclosed, performed by a first wireless device (WD) for handling sidelink communication with one or more second WDs comprised in a sidelink group associated with a predetermined geographical area. The method comprises obtaining access information for connecting to the sidelink group associated with the predetermined area geographical. The method comprises communicating, based on the access information, with the one or more second WDs in the sidelink group via sidelink.

The present disclosure pertains to the field of wireless communications. The present disclosure relates to a method for handling sidelink communication with one or more second WDs comprised in a sidelink group associated with a predetermined geographical area, a related wireless device, a related radio network node and a related location network node.

### BACKGROUND

The 3rd Generation Partnership Project, 3GPP, Release 17, sidelink enhancements are in the process of being developed. Sidelink and/or sidelink communication refers to device to device (D2D) communication between a plurality of wireless devices (WDs). Sidelink has been developed since release 12 for 3GPP Long Term Evolution (LTE) and has been evolved since then for LTE usage. The interface between the devices is called PC5 (see TS 38.300) and the service layer supporting D2D is called Proximity-based services (ProSe) as specified in TS 23.303.

For 3GPP New Radio (NR) the primary D2D focus has been use cases for vehicle to anything (V2X). Such D2D features have been specified and evolved since NR release 16. The focus has been on typical V2X use cases such as platooning, remote driving, advanced and coordinated driving features, sharing sensor data between vehicles and pedestrians etc. However, in future releases use cases other than V2X likely will be considered.

In LTE only broadcasted sidelink transmissions, such as transmissions between all WDs connected to a sidelink cluster, are supported. Accordingly, all WDs in the sidelink cluster receive the sidelink transmissions, which may lead to a waste of resources and a high power consumption in a wireless communications network in the case the information broadcasted in the sidelink is not relevant to all WDs in the sidelink cluster.

### SUMMARY

Accordingly, there is a need for devices and methods for handling sidelink communication between one or more WDs comprised in a sidelink group associated with a predetermined geographical area, which may mitigate, alleviate or address the shortcomings existing and may provide an improved management of resources and reduced power consumption for WDs communicating via the sidelink.

A method is disclosed, performed by a first wireless device (WD) for handling sidelink communication with one or more second WDs comprised in a sidelink group associated with a predetermined geographical area. The method comprises obtaining access information for connecting to the sidelink group associated with the predetermined area geographical. The method comprises communicating, based on the access information, with the one or more second WDs in the sidelink group via sidelink.

Further, a wireless device is provided, the wireless device comprising memory circuitry, processor circuitry, and a wireless interface. The wireless device is configured to perform any of the methods disclosed herein relating to the wireless device.

It is an advantage of the present disclosure that a WD being located within a predetermined geographical area, such as WDs being located in a factory and/or an office building, may be added to a sidelink group associated with the predetermined geographical area. Information relevant to the WDs in the predetermined geographical area, such as local traffic information between vehicles moving within the predetermined geographical area, or information associated with an activity within the predetermined geographical area, such as business related information, safety related information, and/or event related information associated with the activity within the predetermined geographical area, can be transmitted only to the WDs comprised in the sidelink group associated to the geographical area. WDs not associated with, such as not located in the predetermined geographical area, thereby do not have to receive information which is not relevant to them. The number of resources used for irrelevant information at WDs located outside the geographical area may be reduced, thereby improving the management of resources in the wireless communications network. Further, by only transmitting in the sidelink to WDs within the predetermined geographical area, the power consumption for sidelink transmissions can be reduced compared to broadcasted sidelink transmissions. Moreover, in the case the coverage within the predetermined geographical area varies, the WDs in the sidelink group associated with the predetermined geographical area can relay the information within the geographical area so that WDs in the sidelink geographical area having bad coverage can receive information relevant to the predetermined geographical area.

A method is disclosed, performed by a network node, for handling sidelink communication for a group of WDs associated with a predetermined geographical area. The method comprises obtaining an indication indicative of one or more WDs located in a predetermined geographical area. The method comprises sending, to one or more of the WDs comprised in the list of WDs, access information for connecting to a sidelink group associated with the predetermined geographical area.

Further, a network node is provided, the network node comprising memory circuitry, processor circuitry, and a wireless interface. The network node is configured to perform any of the methods disclosed herein relating to the network node.

It is an advantage of the present disclosure that the network node can handle the sidelink group associated with the predetermined geographical area, such as an addition and/or removal of WDs located in the predetermined geographical area to the sidelink group. By adding the WDs located in the predetermined geographical area to the sidelink group associated with the predetermined geographical area, information relevant to the WDs in the predetermined geographical area, such as local traffic information between vehicles moving within the predetermined geographical area, or information associated with an activity within the predetermined geographical area, such as business related information, safety related information, and/or event related information associated with the activity within the predetermined geographical area, can be transmitted only to the WDs comprised in the geographical area. WDs not associated with, such as not located in the predetermined geographical area, thereby don't have to receive information which is not relevant to them. The number of resources used for irrelevant information at WDs located outside the geographical area may thus be reduced, thereby improving the management of resources in the wireless communications network. Further, by enabling sidelink transmissions only to WDs located within the predetermined geographical area, the power consumption for sidelink transmissions can be reduced compared to broadcasted sidelink transmissions. Moreover, in the case the coverage within the predetermined geographical area varies, the WDs in the sidelink group associated with the predetermined geographical area can relay the information within the geographical area so that WDs in the sidelink geographical area having bad coverage can receive information relevant to the predetermined geographical area.

A method is disclosed, performed by a location network node, for enabling sidelink communication for a group of WDs associated with a predetermined geographical area.

The method comprises receiving information indicative of one or more WDs located in a predetermined geographical area. The method comprises, upon receiving information indicative of a change of WDs located in the predetermined geographical area, sending, to a radio network node, a list of the WDs located in the predetermined geographical area.

Further, a location network node is disclosed, the location network node comprising memory circuitry, processor circuitry, and a wireless interface. The location network node is configured to perform any of the methods disclosed herein relating to the location network node.

It is an advantage of the present disclosure that the location network node can monitor a change of WDs in the predetermined geographical area and may provide information about the WDs located in the predetermined geographical area to the network node. This can enable the network node to continuously update the set of WDs in the sidelink group associated with the predetermined geographical area to enable sidelink communication between the WDs located in the predetermined geographical area. The information provided to the network node can further allow the network node to update authentication and encryption information upon a WD joining and/or leaving the sidelink group. Therefore, unauthorized access to information transmitted in the sidelink group by WDs not located in the predetermined geographical area can be prevented.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a signaling diagram illustrating an example message exchange between a first WD, a network node, a location network node and a set of second WDs comprised in a geographical sidelink group according to this disclosure,

FIG. 3 is a signaling diagram illustrating an example message exchange between a first WD and a set of second WDs comprised in a geographical sidelink group according to this disclosure,

FIG. 4 is a flow-chart illustrating an example method, performed in a wireless device, for handling sidelink communication with one or more second WDs comprised in a sidelink group associated with a predetermined geographical area according to this disclosure, FIG. 5 is a flow-chart illustrating an example method, performed in a network node of a wireless communication system, for handling sidelink communication for a group of wireless devices associated with a predetermined geographical area according to this disclosure,

FIG. 6 is a flow-chart illustrating an example method, performed in a location network node of a wireless communication system, for enabling sidelink communication for a group of wireless devices, WDs, associated with a predetermined geographical area,

FIG. 7 is a block diagram illustrating an example wireless device according to this disclosure,

FIG. 8 is a block diagram illustrating an example network node according to this disclosure, and

FIG. 9 is a block diagram illustrating an example location network node according to this disclosure.

### DETAILED DESCRIPTION

Various examples and details are described hereinafter, with reference to the FIGS. when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

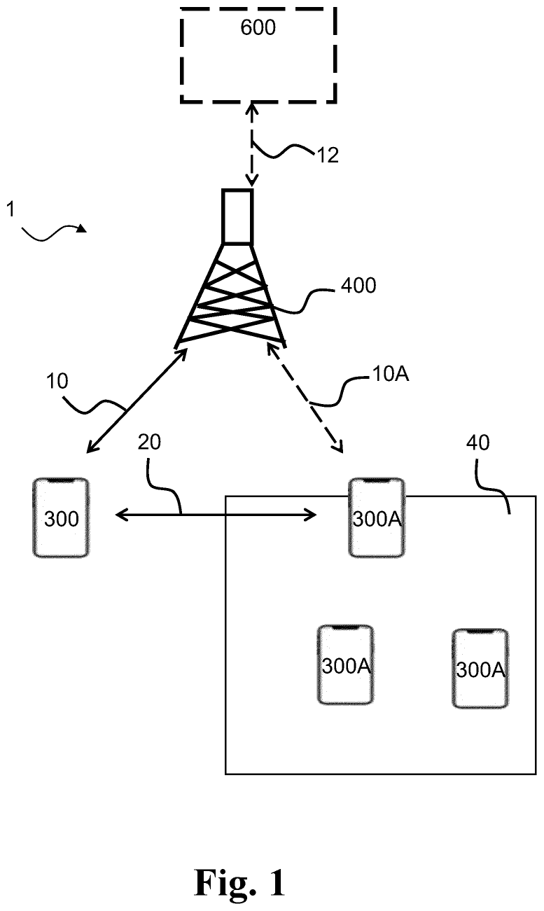

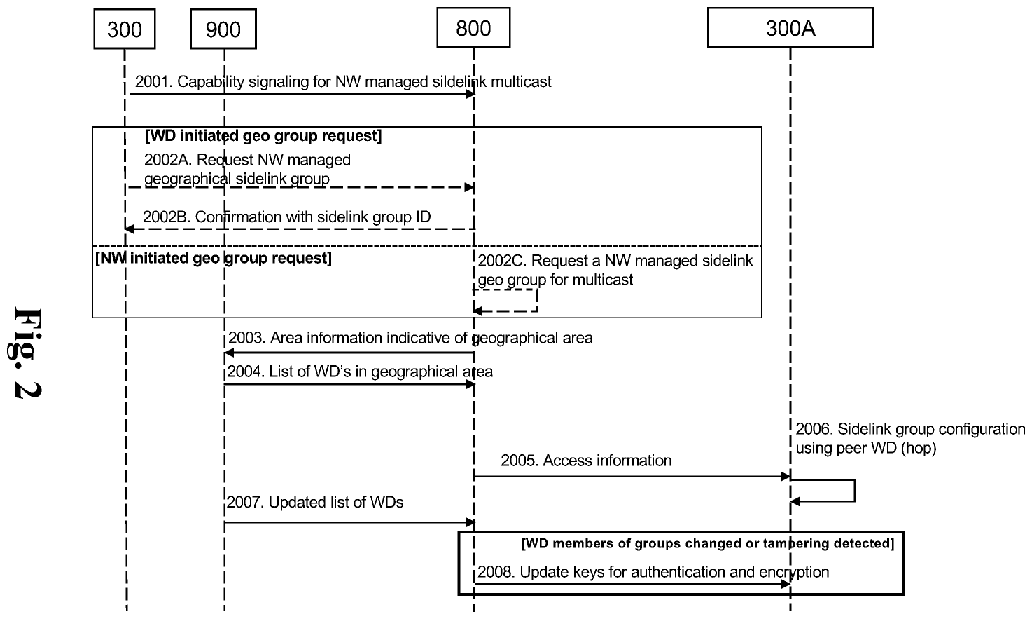

FIG. 1 is a diagram illustrating an example wireless communication system 1 comprising an example radio network node 400 and an example wireless device (WD) 300 according to this disclosure. The wireless communication system 1 optionally comprises an example core network node 600.

As discussed in detail herein, the present disclosure relates to a wireless communication system 1 comprising a cellular system, for example, a 3GPP wireless communication system.

A radio network node 400 disclosed herein refers to a network node operating in the radio access network (RAN), such as a base station, an evolved Node B, eNB, gNB in NR. In one or more examples, the RAN node is a functional unit which may be distributed in several physical units.

A core network, CN, node 600 disclosed herein refers to a network node operating in the core network, such as in the Evolved Packet Core Network, EPC, and/or a 5G Core Network, 5GC. Examples of CN nodes include a Mobility Management Entity (MME), an Access and Mobility Management Function (AMF), a Location Management Function (LMF). A CN node implementing the LMF may herein be referred to as a location network node or a location server (LS). In one or more examples, the CN node 600 is a functional unit which may be distributed in several physical units.

The wireless communication system 1 described herein may comprise one or more wireless devices, such as a first wireless device 300, and a set of second wireless devices 300A, and/or one or more radio network nodes 400, such as one or more of: a base station, an eNB, a gNB and/or an access point. The set of second wireless devices 300A may be one or more second wireless devices comprised in a sidelink group, such as in a predetermined sidelink group.

A wireless device may refer to a mobile device and/or a user equipment (UE).

The wireless device 300, 300A may be configured to communicate with the radio network node 400 via a wireless link (or radio access link) 10, 10A, such as a Universal Mobile Telecommunications System air (Uu) interface.

The core network node 600 may be configured to communicate with the radio network node 400 via a link 12, such as a wired and/or wireless link, and/or with the one or more wireless devices 300, 300A, via the radio network node 400.

The wireless devices 300, 300 may be configured to communicate directly with each other via a sidelink 20, such as without communicating via the radio network node 400. The sidelink 20 may be a wireless link, such as a wireless link via a PC5 interface.

A network node as disclosed herein may refer to a CN node, such as CN node 600, or a radio network node, such as radio network node 400.

A WD 300, 300A configured for sidelink communication may be configured with a ProSe UE ID which is used to identify the receiver when a signal is sent to the WD. Since 3GPP NR D2D communication also supports groupcast, a group of WDs may have its dedicated group ID, which may be referred to as ProSe Layer-2 Group ID which is used in a data transmission when the WD sends data to the group of WDs. Currently the management of the WD belonging to a group is handled in the application layer, while the configuration of the group is handled in a Radio Resource Control (RRC) layer. Handled in the application layer can herein be seen as the management of the WDs belonging to the group being performed in an application function and being signalled from the application layer. Groupcast can herein be seen as communication between all WDs belonging to a group, such as to a sidelink group.

Example use cases for groupcast include vehicle platooning and extended sensors. In the case of extended sensors, sensor information may be exchanged through a lower latency vehicular network where vehicles, pedestrians and/or other type of users share their data in groups interested in the particular data. In the case of platooning, vehicles may follow each other tightly with reduced safety margins enabled by shared information among the vehicles in a vehicular network. A master WD of the platoon of WDs, such as a lead vehicle of the platoon, may multicast, such as groupcast and/or broadcast, commands in the sidelink to control the platoon. Broadcasting can herein be seen as communication between all WDs connected to a sidelink cluster, such as to a communication area in which the sidelink configuration is valid. The master WD may be seen as a WD leading and/or controlling the set of WDs in the sidelink group.

According to the current disclosure, a sidelink group may be defined by a set of WDs, such as one or more WDs 300A, which are associated with, such as located within, a geographical area 40, such as a predetermined geographical area. In one or more example methods, the set of WDs may be defined directly by the network, such as by a network node. In one or more example methods, the set of WDs may be defined by a WD telling, such as signalling, to the network group information, such as the geographical area of the group and/or the WDs comprised in the group, and the network maintains, such as stores, that information (e.g. in a private network). In one or more example methods the set of WDs 300A may be a preconfigured set of WDs. The preconfigured set of WDs may be provided as a list of unique WD identifiers identifying each WD comprised in the sidelink group. The preconfigured set of WDs may for example be WDs belonging to workers, or vehicles at for example a workplace, such as a factory or an office building.

In one or more examples, a company may provide the preconfiguration to employees so that WDs associated with the employees, such as used by the employees, can connect to a sidelink service of the company when at work. The geographical area 40 may, in one or more example methods, be defined by a footprint of a building, such as of the factory and/or the office. A geographical area may herein be defined as a two-dimensional geographical aera, having a width and a length. For example, a geographical area can herein be seen as an area of the earth, such as a city, a region, a building block, and/or one or more buildings. In one or more example methods, the geographical area may be defined by its vertical position, such as based on a floor of a building. The particular dimensions of the geographical area are not limiting, and any type of regular and/or irregular polygonal area can be used. The geographical area may be a pre-set, such as a predetermined, area. The geographical area may be set via user input. One or more WDs in the geographical area may be configured to set the geographical area. In one or more example methods, such as when the set of WDs are a set of platooning vehicles, the geographical area is a moving area centred around a vehicle in the platoon, such as centred around the master vehicle of the platoon. Coordinates of the geographical area associated with the set of WDs may thus change over time.

In one or more example methods, a first sidelink group may be defined by a set of WDs located in one or more specific building(s). In one or more example methods, a second sidelink group may be defined by a set of WDs located on one or more specific floors in the specific building, such as for example on a third and/or a second floor of the specific building. In other words, the geographical area may herein be seen as an area having three dimensions, such as a length, a width and a height. The geographical area may, in one or more example methods, be within a factory, an office, an arena, or in lower coverage area occasionally having a larger amount of WDs, such as a remote area where for example a rally or a bicycle race takes place. In this geographical area 40, a plurality of WDs 300A, such as some or all the WDs 300A located in the geographical area 40, may belong to the same sidelink group, such as to the same sidelink multicast group.

When a WD 300A is leaving the geographical area 40, the WD 300A may be removed as a member of the sidelink group associated with the geographical area. The WD 300A leaving the geographical area may thus not be member of the sidelink group associated with the geographical area anymore.

In one or more example methods, sidelink groups associated with the geographical area 40, herein also referred to as geographical sidelink groups, may be used for spreading information within the geographical area 40. In one or more example methods, sidelink groups associated with the geographical area 40 may be used to relay information when a WD 300A of the sidelink group is out of coverage, such as when the WD 300A is located in an area having limited coverage, such as in a basement. The information may for example be relayed using a plurality of WDs 300A, such as forwarding the information via a number of WDs in the sidelink group. Relaying the information via a plurality of WDs 300A may herein also be referred to as multi-hop routing. In multi-hop routing the network coverage area can be larger than the radio range of single nodes, such as of single WDs. Therefore, to reach a receiving node, such as a receiving WD, located outside of the radio range of the source node, such as of a source WD, other nodes, such as other WDs, may be used as relay nodes. Every step of a chain of relay nodes can herein be referred to as a hop. A hop can herein be seen as a retransmission of a transmitted signal at a relay node. In other words, if a signal is transmitted from a source node to a relay node which retransmits the signal to the receiver node, the communication may be referred to as a two-hop communication. The first hop being the transmission from the source node to the relay node and the second hop being the transmission from the relay node to the receiver node. It can also be used on Internet of Things (IoT) devices with positioning capability, such as on tags on items which are detected and tracked once they are entering a factory. In, for example, a factory geographical sidelink groups can be used for local traffic information between WDs, such as vehicles, in the factory. The vehicles in the factory may for example be fork-lifts, industrial trucks, and/or transportation robots moving within the factory. Since these vehicles have an operation of service within a limited area of the industrial facility, there is no reason to spread information, such as the local traffic information, to sidelink capable WDs that are located outside the geographical area, such as the factory, associated with the sidelink group. By associating the WDs 300A located within the predetermined geographical area 40 with a specific sidelink group, such as a geographical sidelink group, the communication, such as the spreading of information, can be limited to the WDs comprised in the predetermined geographical area.

In one or more examples, WDs 300A located within a geographical area having poor 3GPP coverage, such as WDs 300A located in a mall having poor 3GPP coverage, can act as relay nodes for WDs 300A further inside the mall and being without coverage.

The WDs 300A comprised in the sidelink group may, in one or more example methods, be defined by a list of WDs, each WD being defined by a respective WD identity, such as a 3GPP Layer 2 (L2) identity. The L2 identity may for example be signalled in a sl-Sourceldentity-RemoteUE field using RRC signalling in the RAN. This field can be used to indicate the Source Layer-2 ID to be used to establish a sidelink, such as a PC5 link, with a L2 UE-to-network (U2N) relay UE. The sidelink group may be defined by the geographical area it is associated with. In other words, the sidelink group is made up of, such as comprises, the WDs located in the geographical area and being capable of communicating via sidelink 20 are comprised in the sidelink group. When a new WD, such as the WD 300, enters the geographical area associated with the sidelink group, the identity, such as the L2 identity, of the WD may be added to the list of WDs defining the sidelink group. This may be done according to 3GPP TS 23.287, section 6.3.2.

In one or more example methods, a sidelink capable WD, such as the first WD 300 of FIG. 1, may be configured, such as preconfigured, with area information relating to the predetermined geographical area 40. In one or more example methods, the area information may be indicative of the geographical area 40 associated with a sidelink group, such as to the group of WDs 300A located in the geographical area 40. In one or more example methods, the area information may be received by the first WD 300 upon entering the geographical area associated with the sidelink group. A sidelink capable WD can herein be seen as a WD being capable of communicating using sidelink, such as a WD being capable of communicating via a 3GPP PC5 interface. The area information may be indicative of the geographical area 40 that the sidelink group is associated with, such as geographic coordinates or an altitude defining the geographical area and/or a sidelink group ID identifying the sidelink group associated with the geographical area 40. In one or more example methods, the area information may be signalled when the first WD 300 is entering a tracking area, such as coverage area of a set of cells associated with a common tracking area code, associated with the predetermined geographical area of the sidelink group. The tracking area may cover a larger area than the predetermined geographical area. The tacking area may surround the predetermined geographical area, such that a WD entering the predetermined geographical area first enters the tracking area, where it may receive the area information of the predetermined geographical area.

In one or more example methods, the area information may be sent in broadcast information from a network node, such as from the radio network node 400, such as from cells, close to or with coverage within the predetermined geographical area associated with the sidelink group

In one or more example methods, upon the first WD 300 entering the predetermined geographical area 40, the first WD 300 may start listening to the sidelink group ID. The first WD 300 may send a discovery signal to the sidelink group, such as to the WDs 300A in the sidelink group, when entering the predetermined geographical area 40, or within a predefined time after the first WD 300 has entered the predetermined geographical area 40. Thereby, the first WD 300 may be tracked or the first WD 300 may communicate with the sidelink group once it enters the predetermined geographical area 40. Once the first WD 300 enters the geographical area 40 and is added to the sidelink group it may be referred to as a WD 300A located within the geographical area 40. Accordingly, upon leaving the predetermined geographical area, the first WD 300 may leave and/or may be removed from the sidelink group. In one or more example methods, the first WD 300 may send a message to the sidelink group, such as to the WDs 300A comprised in the sidelink group, indicating that it is leaving, so that the first WD 300 is removed from the list of WDs defining the sidelink group. In one or more example methods, the network node, such as the radio network node 400, may obtain, such as receive from the location network node, an indication that the first WD has left the predetermined geographical area. Based on the obtained indication, the network node may initiate a removal of the first WD from the sidelink group associated with the predetermined geographical area.

In one or more example methods, end to end security, as defined in TS 33.303 v. 17.0.0 and 23.303 for LTE, is applied on signals sent to other WDs 300A in the predetermined geographical group. A secret, such as a secret key, such as a Secret Signing Key (SSK), in the security may be changed once a WD leaves the predetermined geographical area and thereby the sidelink group associated with the predetermined geographical area. In one or more example methods, the security used may be ProSe one-to-one communication security using Elliptic Curve-based Certificateless Signatures for Identity-based Encryption (ECCSI) and Sakai-Kasahara Key Encryption (SAKKE).

In one or more example methods, the WDs 300A, such as source WDs and/or destination WDs, in the sidelink group defined by WDs 300A located in the geographical location, such as in the predetermined geographical area, may be managed by the network or by an application layer. A source WD can herein be seen as a WD transmitting in sidelink, and a destination WD can be seen as a WD receiving in sidelink. The solution according to this disclosure can be used to, for example, complement multicast transmission from a network node for a set of WDs with the addition of a geographical area based sidelink group configuration hosted in the network or distributed and hosted by one or more master and/or source WDs. The sidelink group may be defined by a preconfigured set of WDs 300A which are within a certain area. In one or more example methods, the preconfigured set of WDs 300A may comprise a pre-defined list of a limited number of WDs, such as a total of a hundred preconfigured WDs. In one or more example methods, when any of these preconfigured WDs enter the geographical location, they may be included in the sidelink group associated with the geographical area. Any WD 300 that enters the geographical location and is not in the pre-defined list may not get included in the sidelink group. The preconfigured set of WDs 300A may for example belong to people employed at a site of the geographical area or tags used on goods in the geographical area. In one or more example methods, the preconfigured set of WDs may be all WDs using sidelink in a predetermined geographical area, such as in a public area.

In one or more example methods, end-to-end security may be applied to the sidelink communication, such as to signals sent to the other WDs 300A in the geographical sidelink group. The end-to-end security may for example be applied by embedding authentication to the communication in the sidelink. In one or more example methods, authentication can be embedded by setting up the WDs of the sidelink group to listen to messages encrypted for the specific sidelink group. A set of keys to be used for encryption of the messages may thus be distributed to the WD comprised in the sidelink group. In one or more example methods, a new set of keys can be distributed to the WDs 300A in the sidelink group each time a WD enters and/or leaves the sidelink group. In one or more example methods, a new set of keys can be distributed to the WDs 300A in the sidelink group upon a tampering with the set of keys being detected. In one or more example methods, a new set of keys can be distributed to the WDs 300A in the sidelink group upon a node having its security and/or set of keys compromised.

In one or more example methods, a distributed authentication solution, such as a blockchain-based authentication solution, may be applied. In the distributed authentication solution, each node, such as each WD 300A, is part of the authentication procedure of the full sidelink group. Each WD 300A may thus easily detect any tampering of the set of keys.

In one or more example methods, a location network node, such as a Location Server (LS), may determine which WDs that are located in the geographical area defined for the sidelink group. In one or more example methods, the WD 300 itself may, based on its location, request to be included into the group, for example by sending a discovery signal to the other WDs 300A in the sidelink group. The discovery signal may be sent by the WD 300 via sidelink 20, such as via the PC5 interface. The discovery signal may be sent by the WD 300 upon the WD 300 entering the geographical area 40 associated with the sidelink group, such as with the WDs 300A located in the predetermined geographical area 40.

FIG. 2 shows a signalling diagram illustrating an example message exchange between a first WD 300, a network node 800, a location network node 900 and a set of second WDs 300A comprised in a sidelink group, when the location network node 900 is used for determining which WDs are located in the geographical area of the sidelink group. The network node may be a radio network node, such as radio network node 400 disclosed in FIG. 1, or a core network node, such as core network node 600 disclosed in FIG. 1.

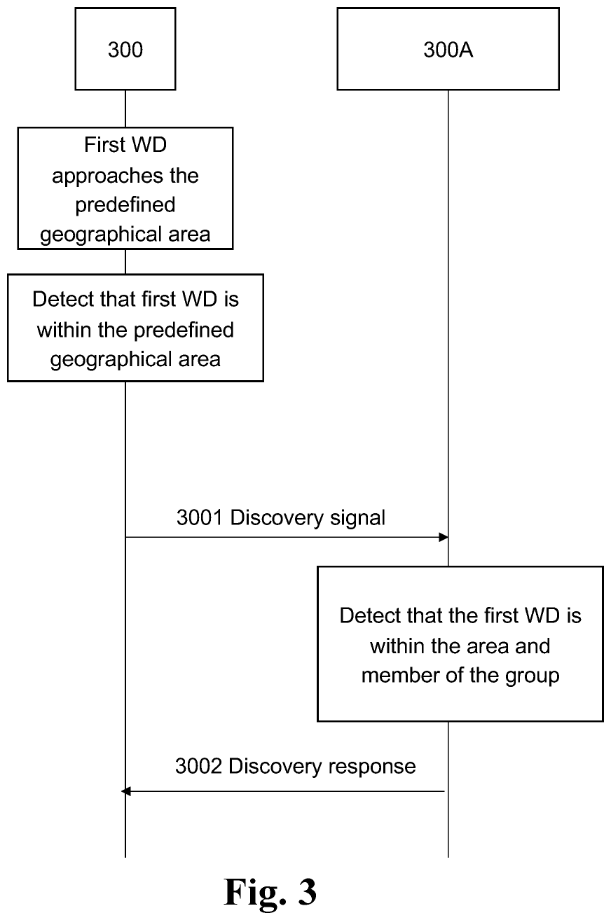

A first WD 300 may send capability signalling 2001, to the network 800, comprising information indicative of the first WDs capability 2001 to use sidelink multicast. In one or more example methods, the capability signalling may comprise a request to use sidelink multicast. The capability signalling may for example be indicative of the first WDs capability to use a functionality of having WD discovery of the sidelink group (as described in relation to FIG. 3), network (NW) initiated sidelink groups, WD initiated sidelink groups or any combination thereof. In one or more example methods, the capability signaling may comprise an indication indicative of the first WDs capability to use certain authentication and/or encryption techniques for the sidelink multicast. This may for example be the case if a distributed authentication method is deployed which may require a different capability from the first WD 300.

A sidelink group associated with a predetermined geographical area, which may herein be referred to as a geographical sidelink group, may be requested. In one or more example methods, the first WD 300 may send the request 2002A for the geographical sidelink group to the network node 800, such as to a network node or a core network node. In one or more example methods, the network node 800 may send the request 2002C for the geographical sidelink group. The geographical sidelink group may for example be requested for the purpose of using sidelink multicast within a limited geographical area, such as within one or more buildings. The request 2002A, 2002C may comprise configuration information of the sidelink group, such as coordinates of the geographical area. In one or more example methods, such as when the geographical area is a 3D range, such as a volume, where also altitude is a part of the geographical location for the geographical area, the request may also comprise information about the altitude of the geographical area. The network node 800 may create the sidelink group associated with the geographical area and may assign a sidelink group ID unique for the created sidelink group. In case the sidelink group has been requested by the first WD 300, the request for 2002A may comprise the identity, such as the L2 identity, of the first WD indicating that the first WD is the initiator or source of the sidelink group. The sidelink group may be assigned with a single source or a plurality of sources, such as having a single initiator or a plurality of initiators, such as a plurality of WDs that are allowed to transmit information in the sidelink group. The first WD may subscribe to the sidelink group by its identity, typically its Layer 2 identity.

In case the first WD 300 sent the request for the sidelink group, the first WD 300 may receive a confirmation message 2002B from the network 800. The confirmation message may comprise information being indicative of one or more of a group ID, resource assignments, a set of keys and methods for authentication and encryption associated with the created sidelink group. The information being associated with the created sidelink group can herein be seen as information to be used for accessing the sidelink group.

In one or more example methods, the location functionality in the network may be deployed in a location network node 900, such as in the LS. The location network node 900 may support the network node 800 in determining the WDs that are present at certain locations. In one or more example methods according to the current disclosure, the location network node 900 may be configured to support the network node 800 in determining the WDs that are present in the geographical area associated with the sidelink group. The network node 800 may send a message 2003 to the location network node 900 comprising information indicative of the geographical area associated with the sidelink group. The message 2003 may for example comprise coordinates or other reference points to geographically constrained areas, such as an address pointing to a certain building, a floor of a building, etc. The message 2003 may comprise a request for information about the WDs located in the indicated geographical area.

The location network node 900 may send a response message 2004 to the network node 800. The response message 2004 may comprise a confirmation confirming the request from the network. The response message 2004 may comprise information about the WDs currently located in the geographical area indicated in the message 2003 received from the network node 800. The WDs currently located in the geographical area may be indicated in a list of WDs indicated by their respective identifier, such as their respective L2 identifier.

The network node 800 may, based on the information about the WDs in the geographical area and the information indicative of the WDs capabilities, determine a set of WDs to include in a sidelink group setup request. When the first WD 300 has been added to the sidelink group it may be part of the set of second WDs 300A comprised in the sidelink group.

The network node 800 may configure the WDs within the geographical area and/or that have indicated that they are capable of supporting sidelink multicast, to communicate using sidelink multicast in the geographical area. The network node 800 may send a configuration message 2005 to the WDs 300A located in the geographical area, to configure the sidelink group associated with the geographical area. The configuration message may comprise access information 2005 for connecting to the sidelink group, such as one or more of the sidelink group ID of the sidelink group associated with the geographical area, authentication information for authenticating the first WD 300 for communication with the sidelink group, encryption information for encrypting and/or decrypting the communication with the sidelink group, the set of keys, and information indicative of the resources, such as time and frequency resources, to use for multicast sidelink transmission and/or reception. The authentication information may comprise information about the type of authentication and an identifier identifying the first WD 300. In one or more example methods, the authentication information may comprise information indicative of a distributed authentication configuration, such as a blockchain-based authentication configuration. The encryption information may comprise information about the type of encryption used, and/or the set of keys used for encryption and/or decryption of the communication with the sidelink group. Since the first WD 300 is now part of the set of second WDs 300A in the sidelink group it will also receive the access information 2005 and can thereby communicate with the other WDs 300A in the sidelink group associated with the geographical area.

In one or more example methods, the WDs in the sidelink group can be configured for multicast hops. Multicast hops may enable WDs not within range of a source WD but located in the geographical area to also listen to the multicast payload, by relaying the payload via one or more WDs 300A in the sidelink group. One or more of the WDs 300A may thus forward the configuration message 2006 for configuring the geographical sidelink group to other WDs 300A in the sidelink group via a defined number of hops. The configuration message 2006 may be forwarded using an authentication method supporting hops. The configuration message may be forwarded by unicast sidelink transmission or via a network node if the network node is within coverage of the WDs 300A in the sidelink group. In one or more example methods, such as when a blockchain-based authentication is carried out, an exchange of the set of keys may be performed by forwarding the set of keys as is to a new WD entering the sidelink group. In other words, any of the WDs in the sidelink group may use their ledger and may add a WD to the sidelink group. Any of the WDs may provide the new WD with the set of keys for listening to a group casted message. This can be seen as a distributed authentication method, which has been moved from the network into the WDs in the sidelink group.

Upon a WD moving into or out from the geographical area, the WD may be added to or removed from the sidelink group associated with the geographical area. The location network node may keep track of this, such as may determine a change of the WDs located in the geographical area. Upon the location network node 900 determining that a change of the WDs in the geographical area has changed, the location network node 900 may send an update message 2007 to the network node 800 indicating what WDs are candidates for removal from and/or addition to the sidelink group.

Upon a WD being removed from and/or added to the sidelink group, and/or if any node in the system, such as the location network node 900, the network node 800, and/or one or more of the WDs 300A in the sidelink group, identifies tampering or a key of the set of keys being compromised, a reauthentication may be made and a new set of keys may be generated and distributed to WDs 300A in the sidelink group. The network node 800 may send a reconfiguration message 2008 to the WDs 300A, the reconfiguration message 2008 comprising one or more of a new set of keys for authentication and encryption and information indicative of when in time the new set of keys is to be applied. The WDs 300A in the sidelink group may proceed with the sidelink communication, such as the sidelink multicast communication, using the new set of keys.

FIG. 3 shows a signalling diagram illustrating an example message exchange between a first WD 300, and a set of second WDs 300A comprised in the sidelink group, when the first WD 300 itself requests to be added to the sidelink group in a predetermined geographical area. In one or more example methods, the first WD 300 may be configured with a predetermined geographical area associated with a sidelink group. The first WD 300 may request itself to become participant of the sidelink group when passing the boundary of the predetermined geographical area of the sidelink group. In one or more example methods, area information, such as coordinates of the predetermined geographical area, may be signalled to the first WD 300 when the first WD 300 is entering the geographical area associated with the sidelink group. In one or more example methods, the area information may be broadcasted to the first WD 300 by network nodes close to or with coverage within a predetermined geographical area. The first WD 300 may thus receive the area information before it enters the predetermined geographical area. Based on the area information the first WD 300 may detect when it enters the predetermined geographical area.

Upon the first WD 300 entering the predetermined geographical area and detecting that it is within the predetermined geographical area, it may send a discovery signal 3001 to a set of second WDs 300A in the sidelink group. The discovery signal 3001 may be sent by the first WD 300 within a predefined time after entering the predetermined geographical area. The discovery signal 3001 may comprise an identifier identifying the first WD, such as may comprise the L2 identity of the first WD 300. The discovery signal 3001 may be transmitted via sidelink, such as via the PC5 interface to the set of second WDs 300A in the sidelink group.

Upon receiving the discovery signal 3001, one or more of the WDs in the set of second WDs 300A in the sidelink group may detect that the first WD 300 is located within the geographical area associated with the sidelink group and that the first WD 300 is part of the sidelink group.

Once the WDs 300A in the sidelink group have detected that the first WD 300 is located within the predetermined geographical area, one or more of the set of second WDs 300A may send a discovery response message 3002 to the first WD 300. The discovery response message 3002 may comprise access information for connecting to the sidelink group, such as one or more of the sidelink group ID of the sidelink group associated with the geographical area, authentication information, encryption information, the set of keys, and information indicative of the resources, such as time and frequency resources, to use for multicast sidelink transmission and/or reception. The authentication information may comprise one or more of an L2 identifier, subscriber information and a certificate (CERT), such as a Root certificate authority (CA) certificate, for identifying the first wireless device.

The encryption information may comprise the set of keys for encryption of the communication within the sidelink group.

The first WD 300 may thus be tracked by the other WDs 300A in the sidelink group and/or the first WD 300 may communicate with the other WDs 300A in the sidelink group, without the location network node being involved. In one or more example methods, the management of the WDs belonging to the sidelink group may thus be partly or fully handled by the WDs 300, 300A.

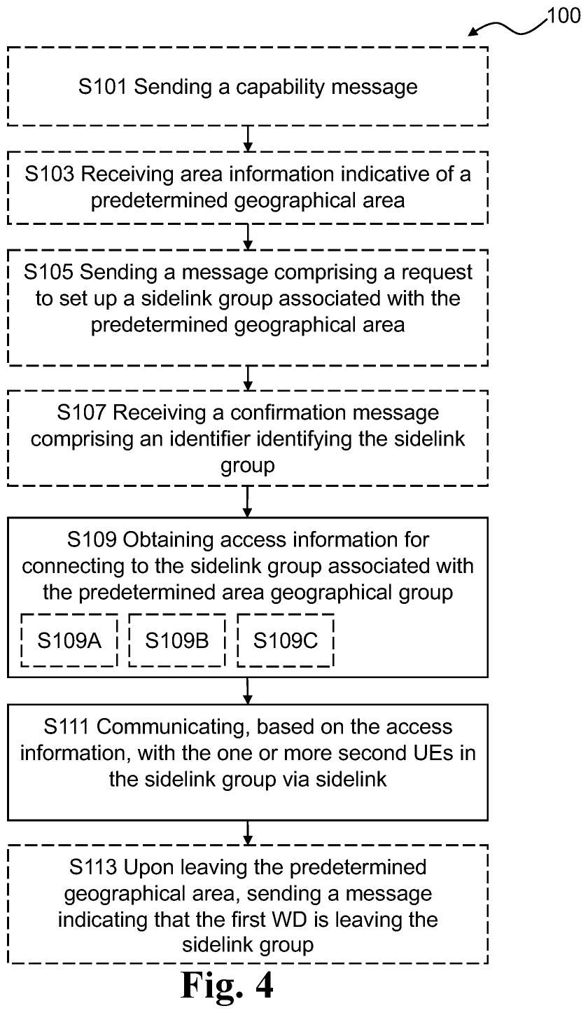

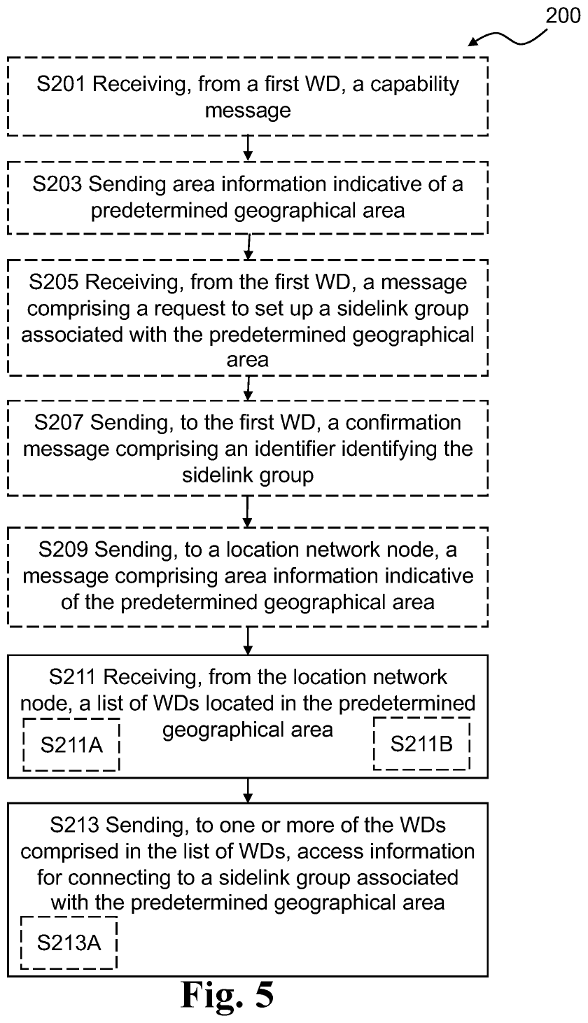

FIG. 4 shows a flow diagram of an example method 100, performed by a first WD, according to the disclosure, for handling sidelink communication with one or more second

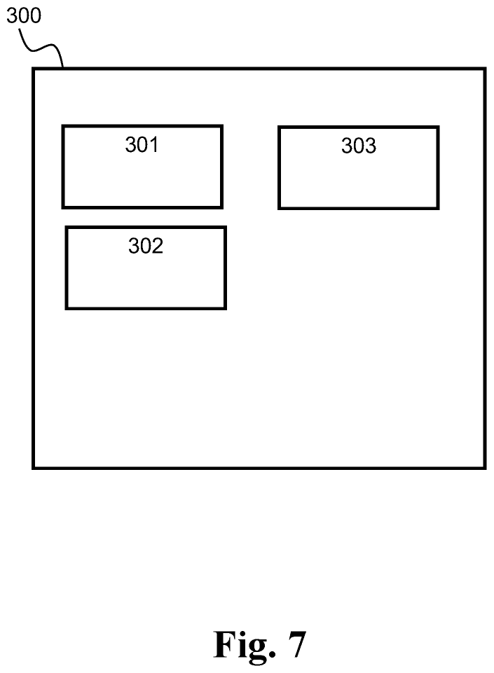

WDs comprised in a sidelink group associated with a predetermined geographical area. The first wireless device is the first wireless device disclosed herein, such as the wireless device 300 of FIG. 1, FIG. 2, FIG. 3, and FIG. 7.

In one or more example methods, the method 100 comprises sending S101, to a network node, such as to a radio network node and/or core network node, a capability message comprising an indication indicative of the WDs capability to support sidelink communication associated with a geographical area.

In one or more example methods, the method 100 comprises receiving S103, from the network node, area information indicative of the predetermined geographical area. The area information may comprise one or more of geographic coordinates, a third dimension, such as an altitude, defining the geographical area and a sidelink group ID identifying the sidelink group associated with the predetermined geographical area. The area information may be received upon the first WD entering the predetermined geographical area or may be received in the broadcast information of cells close to or with coverage within the predetermined geographical area.

In one or more example methods, the method 100 comprises sending S105, to the network node, a message comprising a request to set up the sidelink group associated with the predetermined geographical area. The first network node may thus request the radio network node to set up, such as to form, a sidelink group associated with the predetermined geographical area which sidelink group is to be managed by the network.

In one or more example methods, the method 100 comprises receiving S107, from the network node, a confirmation message comprising an identifier identifying the sidelink group. The identifier may be an L2 identifier.

The method 100 comprises obtaining S109 access information for connecting to the sidelink group associated with the predetermined geographical area. The access information comprises one or more of an identifier for identifying the sidelink group, authentication information for authenticating the first WD for communication with the sidelink group, encryption information for encrypting the communication within the sidelink group, and a set of resources, such as time and frequency resources, for communicating with the sidelink group. The authentication information may comprise one or more of an L2 identifier, subscriber information and a certificate (CERT), such as a Root certificate authority (CA) certificate, for identifying the first wireless device. The encryption information may comprise a set of keys for encryption of the communication within the sidelink group.

In one or more example methods, obtaining S109 access information comprises sending S109A, via sidelink, a discovery signal. Sending S109A corresponds to sending the discovery signal 3001 in FIG. 3. The discovery signal may for example be sent by the first WD when the management of the WDs belonging to the sidelink group is done by the WDs, such as the first WD and/or the one or more second WDs 300A in the sidelink group.

In one or more example methods, obtaining S109 the access information comprises receiving S109B, via sidelink, a discovery response message comprising the access information. Receiving S109B the discovery response message corresponds to receiving the discovery response 3002 in FIG. 3.

In one or more example methods, obtaining S109 access information comprises receiving S109C, from the network node, the access information for connecting to the sidelink group. Receiving S109C corresponds to receiving the confirmation comprising the sidelink group ID 2002B of FIG. 2.

The method 100 comprises communicating S111, based on the access information, with the one or more second WDs in the sidelink group via sidelink.

In one or more example methods, the method 100 comprises, upon leaving the predetermined geographical area, sending S113, to the one or more second WDs, a message indicating that the first WD is leaving the sidelink group. Based on the indication sent by the first WD, the one or more second WDs may remove the first WD from the sidelink group associated with the predetermined area.

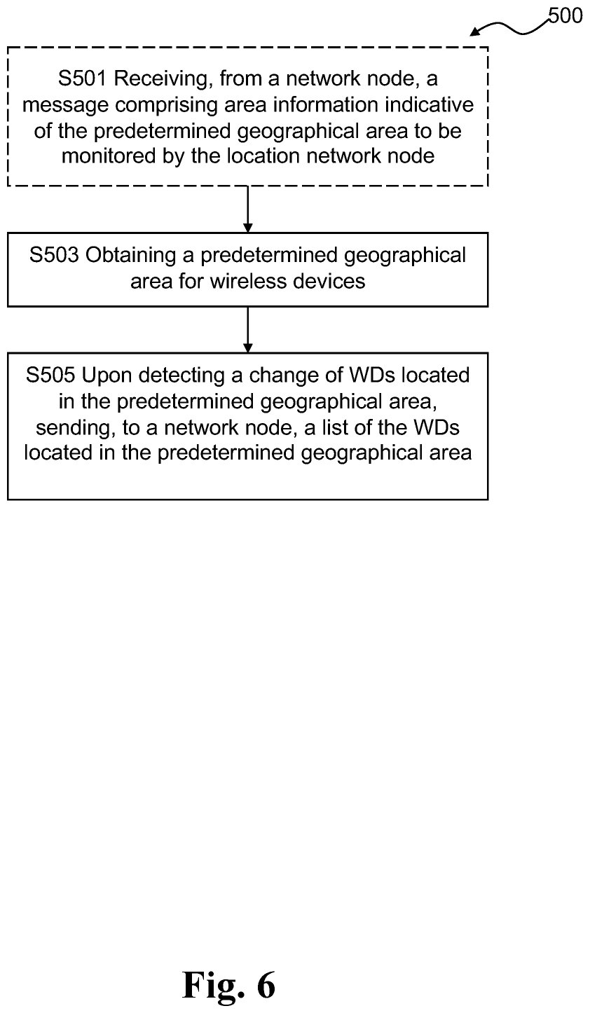

FIG. 5 shows a flow diagram of an example method 200, performed by a network node according to the disclosure, for handling sidelink communication for a group of wireless devices, WDs, associated with a predetermined geographical area. The network node is the network node disclosed herein, such as the network node 800 of FIG. 6, such as the radio network node 400 of FIG. 1 and/or the CN node 600 according to FIG. 1.

In one or more example methods, the method 200 comprises receiving S201, from the first WD, a capability message comprising an indication indicative of the first WD's capability to support sidelink communication associated with a geographical area.

In one or more example methods, the method 200 comprises sending S203 area information indicative of the predetermined geographical area.

In one or more example methods, the method 200 comprises receiving S205 a message comprising a request to set up the sidelink group associated with the predetermined geographical area. In one or more example methods, the message may be received from the first WD, such as from an application function via an application layer of the first WD.

In one or more example methods, the message may be received from an application function in the network and being signaled via the application layer of the network, such as of the network node. In one or more example methods, the message may be received from an internal part of the network, such as from the core network or from the location network node.

In one or more example methods, the method 200 comprises sending S207, to the first WD, a confirmation message comprising an identifier identifying the sidelink group. The identifier may, in one or more example methods, be an L2 identifier identifying the sidelink group.

In one or more example methods, the method 200 comprises sending S209, to the location network node, a message comprising area information indicative of the predetermined geographical area. The area information may be used by the location network node to setup the predetermined geographical area to monitor for WDs, such as to monitor for a change of WDs, such as WDs entering or leaving the predetermined geographical area.

The method 200 comprises obtaining S211 an indication indicative of one or more WDs located in a predetermined geographical area. The indication may be obtained every time a WD enters or leaves the predetermined geographical area.

In one or more example methods, obtaining S211 the indication comprises receiving S211A, from a location network node, a list of WDs located in the predetermined geographical area.

In one or more example methods, obtaining S211 the indication comprises receiving S211B, from a WD, an indication indicating that the WD is located in the predetermined geographical area.

The method 200 comprises sending S213, to one or more of the WDs located in the predetermined geographical area, access information for connecting to a sidelink group associated with the predetermined geographical area. In one or more example methods, the access information comprises one or more of: an identifier identifying the sidelink group, authentication information for communicating with the sidelink group, encryption information for communicating with the sidelink group, and a set of resources for communicating with the sidelink group. In one or more example methods, the authentication information and/or the encryption information comprises a set of keys for authentication and encryption of the communication with the sidelink group. The set of resources may be a set of time and/or frequency resources. The access information may, in one or more example methods, be sent in a control message.

Upon receiving an indication indicative of a change of the WDs located in the predetermined geographical area, the network node may send S213A updated access information to the one or more of the WDs located in the predetermined geographical area. The updated access information may comprise updated authentication information and/or encryption information. By updating the access information, the network node can prevent unauthorized WDs, such as WDs not located within the predetermined geographical area, from accessing information related to the predetermined geographical area.

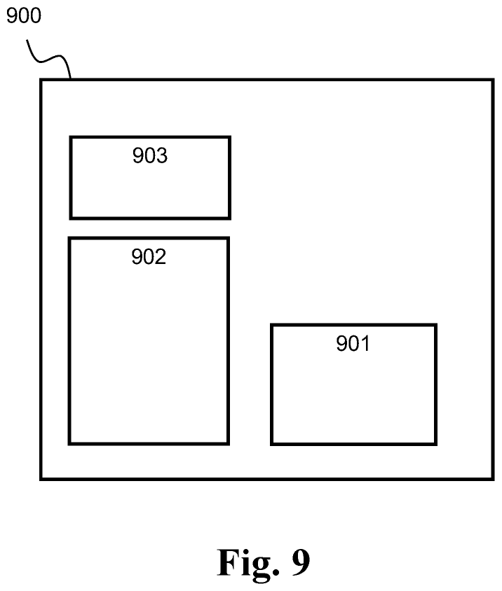

FIG. 6 shows a flow diagram of an example method 500, performed by a location network node according to the disclosure, for enabling sidelink communication for a group of WDs associated with a predetermined geographical area. The location network node is the location network node disclosed herein, such as location network node 900 of FIG. 2, and FIG. 9. The location network node 900 may be a location server located in the core network and/or a location management function executed in a core network, such as in the core network node 600 of FIG. 1.

In one or more example methods, the method 500 comprises receiving S501, from the network node, such as from the radio network node and/or the core network node, a message comprising area information indicative of the predetermined geographical area to be monitored by the location network node. Based on the area information the location network node may setup the predetermined geographical area to monitor for WDs, such as to monitor for a change of WDs, such as to monitor for WDs entering or leaving the predetermined geographical area.

The method 500 comprises obtaining S503 information indicative of one or more WDs located in a predetermined geographical area. Obtaining may comprise receiving the information indicative of the one or more WDs located in the predetermined geographical area from the network node, such as from the radio network node, serving the one or more WDs. The method 500 comprises upon obtaining information indicative of a change of WDs located in the predetermined geographical area, sending S505, to the network node, a list of the WDs located in the predetermined geographical area. The list of WDs, may comprise a unique identifier for each WD located in the predetermined geographical area.

FIG. 7 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 4. In other words, the wireless device 300 may be configured for handling sidelink communication with one or more second WDs comprised in a sidelink group associated with a predetermined geographical area.

The wireless device 300 is configured to communicate with a network node, such as the network node 400 and/or the core network node 600 disclosed herein, using a wireless communication system. The wireless device 300 may be configured to communicate with the core network node 600 via the network node 400.

The wireless device 300 is configured to obtain (such as via the wireless interface 303 and/or via the processor circuitry 301) access information for connecting to the sidelink group associated with the predetermined geographical area.

The wireless device 300 is configured to communicate (such as via the wireless interface 303), based on the access information, with the one or more second WDs in the sidelink group via sidelink.

The wireless interface 303 is configured for wireless communications via a wireless communication system, such as a 3GPP system, such as a 3GPP system supporting one or more of: New Radio, NR, Narrow-band IoT, NB-IoT, and LTE, such as LTE-enhanced Machine Type Communication, LTE-M, millimeter-wave communications, such as millimeter-wave communications in licensed bands, such as device-to-device millimeter-wave communications in licensed bands.

The wireless device 300 is optionally configured to perform any of the operations disclosed in FIG. 4 (such as any one or more of S101, S103, S105, S107, S109, S109A, S109B, S109C, S111, S113). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 7). Memory circuitry 301 is considered a non-transitory computer readable medium.

Memory circuitry 301 may be configured to store information (such as information indicative of access information, sidelink group identifier, authentication information, encryption information, a set of keys, etc.) in a part of the memory.

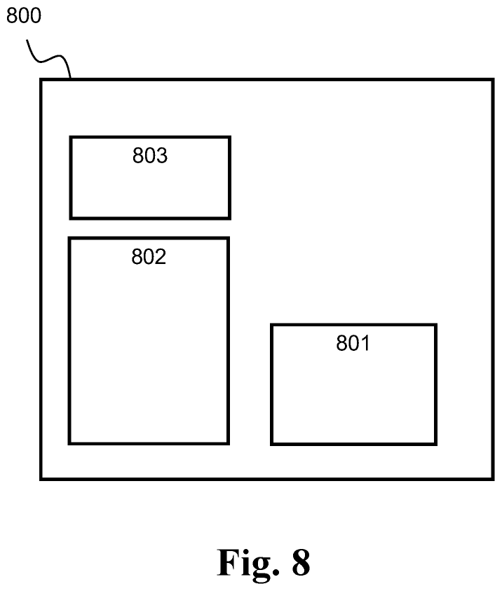

FIG. 8 shows a block diagram of an example network node 800 according to the disclosure. The network node 800 comprises memory circuitry 801, processor circuitry 802, and an interface 803. The interface 803 may be a wired interface or a wireless interface. The network node 800 may be configured to perform any of the methods disclosed in FIG. 5. In other words, the network node 800 may be configured for handling sidelink communication for a group of WDs associated with a predetermined geographical area. The network node 800 may be a radio network node, such as radio network node 400 disclosed in FIG. 1, or a core network node, such as core network node 600 disclosed in FIG. 1.

The network node 800 is configured to communicate with a WD, such as the first WD 300 and/or the one or more second WDs 300A disclosed herein, using a wireless communication system.

The wireless interface 803 is configured for wireless communications via a wireless communication system, such as a 3GPP system, such as a 3GPP system supporting one or more of: New Radio, NR, Narrow-band IoT, NB-IoT, and LTE, such as LLTE-enhanced Machine Type Communication, LTE-M, millimeter-wave communications, such as millimeter-wave communications in licensed bands, such as device-to-device millimeter-wave communications in licensed bands.

The network node 800 is configured to obtain, for example via the wireless interface 803 or using the processing circuitry 802, to the first and second WD, an indication indicative of one or more WDs located in a predetermined geographical area.

The network node 800 is configured to send, for example using the wireless interface 803, to one or more of the WDs comprised in the list of WDs, access information for connecting to a sidelink group associated with the predetermined geographical area.

Processor circuitry 802 is optionally configured to perform any of the operations disclosed in FIG. 5 (such as any one or more of S201, S203, S205, S207, S209, S211, S213). The operations of the network node 800 may be embodied in the form of executable logic routines (for example, lines of code, software programs, etc.) that are stored on a non-transitory computer readable medium (for example, memory circuitry 801) and are executed by processor circuitry 802).

Furthermore, the operations of the network node 800 may be considered a method that the network node 800 is configured to carry out. Also, while the described functions and operations may be implemented in software, such functionality may also be carried out via dedicated hardware or firmware, or some combination of hardware, firmware and/or software.

Memory circuitry 801 may be one or more of a buffer, a flash memory, a hard drive, a removable media, a volatile memory, a non-volatile memory, a random access memory (RAM), or other suitable device. In a typical arrangement, memory circuitry 801 may include a non-volatile memory for long term data storage and a volatile memory that functions as system memory for processor circuitry 802. Memory circuitry 801 may exchange data with processor circuitry 802 over a data bus. Control lines and an address bus between memory circuitry 801 and processor circuitry 802 also may be present (not shown in FIG. 8). Memory circuitry 801 is considered a non-transitory computer readable medium.

Memory circuitry 801 may be configured to store information (such as information indicative of access information, sidelink group identifier, authentication information, encryption information, a set of keys, etc.) in a part of the memory.

FIG. 9 shows a block diagram of an example location network node 900 according to the disclosure. The location network node 900 comprises memory circuitry 901, processor circuitry 902, and a wireless interface 903. The location network node 900 may be configured to perform any of the methods disclosed in FIG. 6. In other words, the location network node 900 may be configured for enabling sidelink communication for a group of WDs associated with a predetermined geographical area.

The location network node 900 is configured to communicate with a network node, such as a radio network node and/or a core network node, disclosed herein, using a communication system.

The wireless interface 903 is configured for wireless communications via a wireless communication system, such as a 3GPP system, such as a 3GPP system supporting one or more of: New Radio, NR, Narrow-band IoT, NB-IoT, and LTE, such a LTE-enhanced Machine Type Communication, LTE-M, millimeter-wave communications, such as millimeter-wave communications in licensed bands, such as device-to-device millimeter-wave communications in licensed bands.

The location network node 900 is configured to obtain, for example via the wireless interface 903, information indicative of one or more WDs located in a predetermined geographical area.

The location network node 900 is configured to, upon obtaining information indicative of a change of WDs located in the predetermined geographical area, send, for example via the wireless interface 903, to a network node, a list of the WDs located in the predetermined geographical area.

Processor circuitry 902 is optionally configured to perform any of the operations disclosed in FIG. 6 (such as any one or more of S501, S503, S505). The operations of the location network node 900 may be embodied in the form of executable logic routines (for example, lines of code, software programs, etc.) that are stored on a non-transitory computer readable medium (for example, memory circuitry 901) and are executed by processor circuitry 902).

Furthermore, the operations of the location network node 900 may be considered a method that the location network node 900 is configured to carry out. Also, while the described functions and operations may be implemented in software, such functionality may also be carried out via dedicated hardware or firmware, or some combination of hardware, firmware and/or software.

Memory circuitry 901 may be one or more of a buffer, a flash memory, a hard drive, a removable media, a volatile memory, a non-volatile memory, a random access memory (RAM), or other suitable device. In a typical arrangement, memory circuitry 901 may include a non-volatile memory for long term data storage and a volatile memory that functions as system memory for processor circuitry 902. Memory circuitry 901 may exchange data with processor circuitry 902 over a data bus. Control lines and an address bus between memory circuitry 901 and processor circuitry 902 also may be present (not shown in FIG. 9). Memory circuitry 901 is considered a non-transitory computer readable medium.

Memory circuitry 901 may be configured to store information, such as area information, in a part of the memory.

Examples of methods and products (wireless device, network node and location network node) according to the disclosure are set out in the following items:
Item 1. A method performed by a first wireless device, WD, for handling sidelink communication with one or more second WDs comprised in a sidelink group associated with a predetermined geographical area, wherein the method comprises:
   obtaining (S109) access information for connecting to the sidelink group associated with the predetermined geographical area, and
   communicating (S111), based on the access information, with the one or more second WDs in the sidelink group via sidelink.
Item 2. The method according to Item 1, wherein obtaining (S109) access information comprises:
   sending (S109A), via sidelink, a discovery signal, and
   receiving (S109B), via sidelink, a discovery response message comprising the access information.
Item 3. The method according to Item 1 or 2, wherein the method comprises:
   upon leaving the predetermined geographical area, sending (S113), to the one or more second WDs, a message indicating that the first WD is leaving the sidelink group.
Item 4. The method according to Item 1, wherein obtaining (S109) access information comprises:
   receiving (S109C), from a network node, the access information for connecting to the sidelink group.
Item 5. The method according to Item 1 or 4, wherein the method comprises:
   sending (S101), to a network node, a capability message comprising an indication indicative of the WDs capability to support sidelink communication associated with a geographical area.
Item 6. The method according to any one of the Items 4 to 5, wherein the method comprises:
   sending (S105), to a network node, a message comprising a request to set up the sidelink group associated with the predetermined geographical area.
Item 7. The method according to Item 6, wherein the method comprises:
   receiving (S107), from the network node, a confirmation message comprising an identifier identifying the sidelink group.
Item 8. The method according to any one of the previous Items, wherein the method comprises:
   receiving (S103), from a network node, area information indicative of the predetermined geographical area.
Item 9. The method according to any one of the previous Items, wherein the access information comprises one or more of:
   an identifier identifying the sidelink group,
   authentication information for communicating with the sidelink group,
   encryption information for communicating with the sidelink group, and
   a set of resources for communicating with the sidelink group.
Item 10. A method performed by a network node, for handling sidelink communication for a group of wireless devices, WDs, associated with a predetermined geographical area, wherein the method comprises:
   obtaining (S211) an indication indicative of one or more WDs located in a predetermined geographical area, and
   sending (S213), to one or more of the WDs comprised in the list of WDs, access information for connecting to a sidelink group associated with the predetermined geographical area.
Item 11. The method according to Item 10, wherein obtaining (S211) the indication comprises:
   receiving (S211A), from a location network node, a list of WDs located in the predetermined geographical area.
Item 12. The method according to Item 10 or 11, wherein obtaining (S211) the indication comprises:
   receiving (S211B), from a WD, an indication indicating that the WD is located in the predetermined geographical area.
Item 13. The method according to any one of the Items 10 to 12, wherein the method comprises:
   sending (S209), to the location network node, a message comprising area information indicative of the predetermined geographical area.
Item 14. The method according to any one of the Items 10 to 13, wherein the method comprises:
   receiving (S205) a message comprising a request to set up the sidelink group associated with the predetermined geographical area.
Item 15. The method according to Item 14, wherein the method comprises:
   sending (S207), to the first WD, a confirmation message comprising an identifier identifying the sidelink group.
Item 16. The method according to any one of Item 10 to 15, wherein the method comprises:
   receiving (S201), from the first WD, a capability message comprising an indication indicative of the first WD's capability to support sidelink communication associated with a geographical area.
Item 17. The method according to any one of the Items 10 to 16, wherein the method comprises:
   sending (S203) area information indicative of the predetermined geographical area.
Item 18. The method according to any one of the Items 10 to 17, wherein the access information comprises one or more of:
   an identifier identifying the sidelink group,
   authentication information for communicating with the sidelink group,
   encryption information for communicating with the sidelink group, and
   a set of resources for communicating with the sidelink group.
Item 19. A method performed by a location network node, for enabling sidelink communication for a group of wireless devices, WDs, associated with a predetermined geographical area, wherein the method comprises:
   obtaining (S503) information indicative of one or more WDs located in a predetermined geographical area, and
   upon receiving information indicative of a change of WDs located in the predetermined geographical area, sending (S505), to a network node, a list of the WDs located in the predetermined geographical area.
Item 20. The method according to Item 19, wherein the method comprises:
   receiving (S501), from the network node, a message comprising area information indicative of the predetermined geographical area to be monitored by the location network node.
Item 21. A wireless device comprising memory circuitry, processor circuitry, and a wireless interface, wherein the wireless device is configured to perform any of the methods according to any of Items 1-9.
Item 22. A network node comprising memory circuitry, processor circuitry, and a wireless interface, wherein the network node is configured to perform any of the methods according to any of Items 10-18.
Item 23. A location network node comprising memory circuitry, processor circuitry, and a wireless interface, wherein the location network node is configured to perform any of the methods according to any of Items 19-20.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1 to 9 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed by a first wireless device (WD) for handling sidelink communication with one or more second WDs comprised in a sidelink group associated with a predetermined geographical area, wherein the method comprises:
obtaining access information for connecting to the sidelink group associated with the predetermined geographical area, and
communicating, based on the access information, with the one or more second WDs in the sidelink group via sidelink.

2. The method according to claim 1, wherein obtaining-access information comprises:
sending, via sidelink, a discovery signal, and
receiving, via sidelink, a discovery response message comprising the access information.

3. The method according to claim 1, wherein the method comprises:
upon leaving the predetermined geographical area, sending, to the one or more second WDs, a message indicating that the first WD is leaving the sidelink group.

4. The method according to claim 1, wherein obtaining-access information comprises:
receiving, from a network node, the access information for connecting to the sidelink group.

5. The method according to claim 1, wherein the method comprises:
sending, to a network node, a capability message comprising an indication indicative of the WDs capability to support sidelink communication associated with a geographical area.

6. The method according to claim 4, wherein the method comprises:
sending, to a network node, a message comprising a request to set up the sidelink group associated with the predetermined geographical area.

7. The method according to claim 6, wherein the method comprises:
receiving, from the network node, a confirmation message comprising an identifier identifying the sidelink group.

8. The method according to claim 1, wherein the method comprises:
receiving, from a network node, area information indicative of the predetermined geographical area.

9. The method according to claim 1, wherein the access information comprises one or more of:
an identifier identifying the sidelink group,
authentication information for authenticating the first WD for communication with the sidelink group,
encryption information for encrypting the communication with the sidelink group, and
a set of resources for communicating with the sidelink group.

10. A method performed by a network node, for handling sidelink communication for a group of wireless devices WDs) associated with a predetermined geographical area, wherein the method comprises:
obtaining an indication indicative of one or more WDs located in a predetermined geographical area, and
sending, to one or more of the WDs comprised in the list of WDs, access information for connecting to a sidelink group associated with the predetermined geographical area.

11. The method according to claim 10, wherein obtaining the indication comprises:
receiving, from a location network node, a list of WDs located in the predetermined geographical area.

12. The method according to claim 10, wherein obtaining the indication comprises:
receiving, from a WD, an indication indicating that the WD is located in the predetermined geographical area.

13. The method according to claim 10, wherein the method comprises:
sending, to the location network node, a message comprising area information indicative of the predetermined geographical area.

14. The method according to claim 10, wherein the method comprises:
receiving a message comprising a request to set up the sidelink group associated with the predetermined geographical area.

15. The method according to claim 14, wherein the method comprises:
sending, to the first WD, a confirmation message comprising an identifier identifying the sidelink group.

16. The method according to claim 10, wherein the method comprises:
receiving, from the first WD, a capability message comprising an indication indicative of the first WD's capability to support sidelink communication associated with a geographical area.

17. The method according to claim 10, wherein the method comprises:
sending area information indicative of the predetermined geographical area.

18. The method according to claim 10, wherein the access information comprises one or more of:
an identifier identifying the sidelink group,
authentication information for communicating with the sidelink group,
encryption information for communicating with the sidelink group, and
a set of resources for communicating with the sidelink group.

19. A method performed by a location network node, for enabling sidelink communication for a group of wireless devices (WDSs) associated with a predetermined geographical area, wherein the method comprises:
obtaining information indicative of one or more WDs located in a predetermined geographical area, and
upon obtaining information indicative of a change of WDs located in the predetermined geographical area, sending, to a network node, a list of the WDs located in the predetermined geographical area.

20. The method according to claim 19, wherein the method comprises:
receiving, from the network node, a message comprising area information indicative of the predetermined geographical area to be monitored by the location network node.

21-23. (canceled)
